(19) United States
(12) Patent Application Publication
(10) Pub. No.: US 2026/0135618 A1
(43) Pub. Date: May 14, 2026

(54) SYSTEM AND DONGLE FOR LIGHT-BASED COMMUNICATION

(71) Applicant: Kyocera Corporation, Kyoto (JP)

(72) Inventors: Sovan Das, Santa Barbara, CA (US); Colin Greenidge, Thousand Oaks, CA (US); Kathleen Hartnett, Palo Alto, CA (US); Daniel Grieder, Ventura, CA (US)

(73) Assignee: Kyocera Corporation, Kyoto (JP)

(21) Appl. No.: 19/381,666

(22) Filed: Nov. 6, 2025

Related U.S. Application Data
(60) Provisional application No. 63/718,372, filed on Nov. 8, 2024.

(51) Int. Cl. H04B 10/116; H04B 10/50; H04W 76/10

(52) U.S. Cl. CPC H04B 10/116; H04B 10/502; H04W 76/10

(57) ABSTRACT

A LiFi system includes an access point and a dongle. The access point and dongle may have similar or the same components for communication of data between each other. The dongle may be miniaturized so that it fits within the palm of an adult human hand. The LiFi dongle includes a housing inside which there is a PCB that contains a photodiode, a laser, and other devices (e.g., for communication to move digitized data within and/or out of the dongle to an attached computing device). The PCB may include a number of holes to facilitate heat transfer. The LiFi dongle may include grooves and feet on the bottom to allow for air flow into the dongle, and a plurality of chambers within the dongle housing to provide for areas for heat transfer and protection from electromagnetic interference.

### CROSS-REFERENCES TO RELATED APPLICATIONS

The present application claims priority to U.S. Provisional Application No. 63/718,372, filed Nov. 8, 2024, the contents of which are incorporated herein by reference in their entirety for all purposes.

### FIELD OF INVENTION

Embodiments described herein relate generally to wireless communication systems, and more specifically to systems, apparatuses, and methods for implementing high-speed data communication using light-based wireless technology—commonly referred to as Light Fidelity (LiFi)—with particular emphasis on miniaturized dongles featuring advanced thermal management and electromagnetic shielding.

### BACKGROUND

Wireless data communication has conventionally relied on radio frequency (RF) electromagnetic waves, as seen in technologies such as WiFi, Bluetooth, and various cellular networks. These RF-based systems have enabled widespread mobile connectivity and ubiquitous access to data. However, they are not without limitations. The finite nature of available RF spectrum leads to congestion, which restricts the achievable data throughput, especially in environments where numerous wireless devices compete for bandwidth. Security is another concern, as RF signals can penetrate walls and obstacles, making them vulnerable to interception and eavesdropping by unauthorized individuals beyond the intended coverage area. Furthermore, RF spectrum usage is subject to regulatory oversight and licensing requirements, and interference from other devices operating in similar frequency bands poses additional challenges.

In response to these limitations, alternative techniques for wireless communication have been explored. One such approach is Light Fidelity (LiFi), which employs visible and non-visible light, such as infrared and ultraviolet, for wireless data transmission. LiFi technology leverages advancements in solid-state light sources, including light emitting diodes (LEDs) and laser diodes, as well as photodetectors, to facilitate high-speed, secure, and interference-resistant wireless connections. The use of light for data transmission offers several inherent advantages. Light-based systems can achieve exceedingly high bandwidths, supporting gigabit-class data rates by exploiting the vast optical spectrum. Security is improved because light signals are generally confined to the physical space in which they are emitted, thereby reducing the risk of signal leakage and unauthorized access. Unlike RF systems, LiFi does not interfere with existing wireless networks and is immune to electromagnetic interference from such sources. LiFi systems also lend themselves to deployment in environments where RF communications are impractical or prohibited, such as aircraft cabins, medical facilities, underwater settings, and even space applications.

Despite the advancements embodied in related art, there remains a recognized need for miniaturized, high-performance LiFi dongle systems that can be seamlessly integrated with a variety of computing devices, including laptops, desktops, mobile phones, and servers. Such systems must effectively address the challenges of heat dissipation, electromagnetic interference shielding, and reliable photonic communication. The ideal solution would be compact enough to fit within the palm of a human hand, thus facilitating convenient use and integration with host devices. It should incorporate efficient thermal management strategies, including the use of thermally conductive vias, airflow channels, and, where necessary, active cooling mechanisms. Electromagnetic compatibility and shielding must be maintained to ensure signal integrity and reliable device operation. Robust, bi-directional data transmission capabilities are required to support both point-to-point and point-to-multipoint configurations, accommodating diverse operational environments such as indoor spaces, underwater locations, vehicles, and aerospace applications. The system should also be compatible with a range of light sources, including GaN laser diodes, vertical-cavity surface-emitting lasers (VCSELs), and LEDs, with the flexibility to produce either white or non-white light according to specific requirements. Finally, it should offer versatile data interfaces, such as USB-C and Ethernet, to ensure broad compatibility with host devices.

Despite the advances described above, there remains a need for miniaturized, high-performance LiFi dongle systems that can be easily integrated with computing devices (such as laptops, desktops, mobile phones, and servers) while overcoming the challenges of heat dissipation, EMI shielding, and robust photonic communication.

### SUMMARY

Embodiments described herein address the aforementioned needs by providing a LiFi system comprised of an access point and a miniaturized dongle, each incorporating advanced features for heat management, electromagnetic interference shielding, and high-speed photonic data communication. These innovations are described in greater detail in the ensuing sections of the application.

### BRIEF DESCRIPTION OF THE DRAWINGS

FIG. 1 provides simplified examples of a wireless communication technology that uses light instead of radio waves in accordance with some embodiments.

FIGS. 2-4 are simplified block diagrams of LiFi communication systems in accordance with some embodiments.

FIG. 5 provides simplified block diagrams of exemplary LiFi system architectures in accordance with some embodiments.

FIG. 6 is a simplified diagram of exemplary LiFi systems based on application types in accordance with some embodiments.

FIG. 7 provides simplified examples of LiFi dongles in accordance with some embodiments.

FIG. 8 provides simplified examples of interior and exterior features of LiFi dongles in accordance with some embodiments.

FIG. 9 provides simplified examples of LiFi dongles including cutaway views in accordance with some embodiments.

FIG. 10 provides simplified examples of cooling features of LiFi dongles in accordance with some embodiments.

FIG. 11 provides simplified examples of heat transfer trajectories of LiFi dongles in accordance with some embodiments.

FIG. 12 provides simplified examples of heat transfer trajectories of LiFi dongles including a cutaway view of an exemplary heat transfer chamber in accordance with some embodiments.

FIG. 13 provides simplified examples of heat generation devices in exemplary LiFi dongles in accordance with some embodiments.

### DETAILED DESCRIPTION

The application relates to a dongle that is shrunken to be approximate in size to a human hand, for implementing LiFi, to be used in a communication system, with thermal management for managing the heat from heat-generating devices including one or more laser light sources and a plurality of semiconductor chips.

As illustrated in the appended figures, various embodiments and configurations of the novel LiFi dongle and associated system are shown.

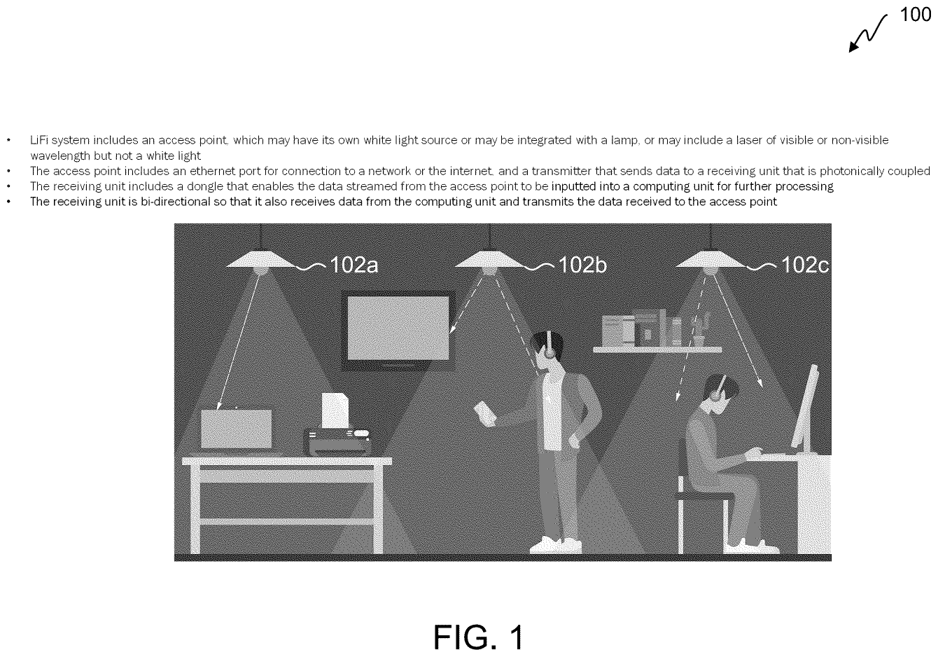

The novel LiFi dongle and system, in some embodiments, includes an access point which may include its own light source (white light or otherwise), or may be integrated with a lamp 102a, 102b, 102c as illustrated in the simplified examples 100 of FIG. 1. The light source may be a laser diode, such as a Fabry-Perot ridge type gallium and nitrogen containing laser diode (“GaN laser diode”), or may be a VCSEL type of laser diode, or other type of laser diode. In some embodiments, the light source may be a non-laser diode such as an LED or other type of light source. If white light is desired, the system may include a phosphor component to affect a wavelength conversion of the laser diode to emanate white light. In some embodiments, the access point may include a non-white light source, for example a blue, green, violet, or infrared laser light source.

The access point may further include a connection to the internet, as well as a transmitter (the light source) that sends data to a receiving unit that is photonically coupled to the access point. The photonic coupling may be achieved by a receiver such as a photodiode in the receiving unit.

The receiving unit includes a dongle that enables the data streamed from the access point to be input into a computing unit for further processing. The receiving unit is bi-directional so that it receives data from the computing unit, and transmits the data received to the access point. The transmitting may be done by a light source, such as a GaN laser diode or infrared light source. The receiving unit light source for transmitting data to the access point may include white light but in other embodiments it may include non-white light. The access point may include a receiver such as a photodiode for receiving the data transmitted via the light source of the receiving unit.

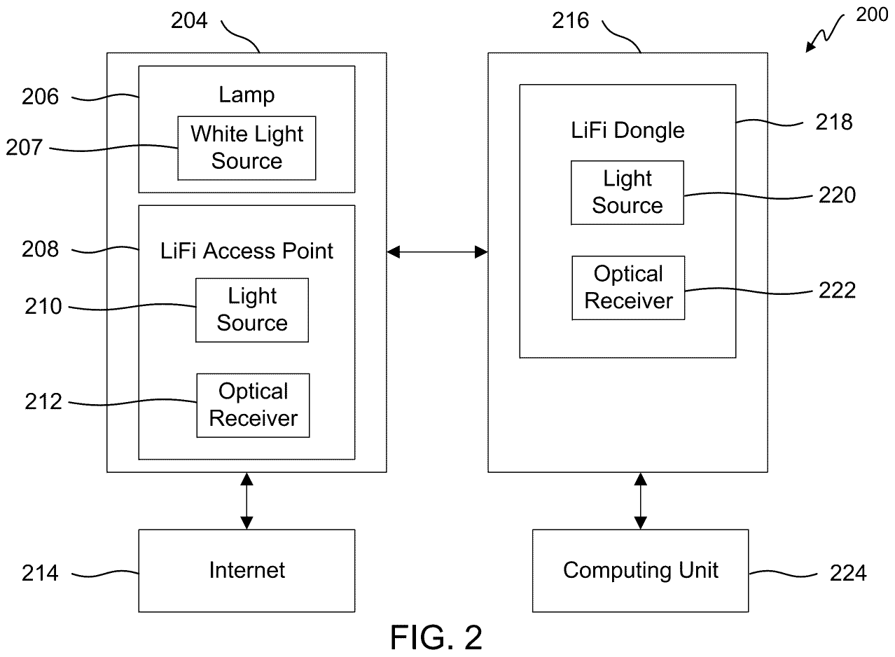

FIG. 2 is a simplified block diagram of a LiFi communication system 200 in accordance with some embodiments. This example includes a first housing 204 comprising a lamp 206 having a white light source 207 and a LiFi access point 208 having a first light source 210 and a first optical receiver 212. The first light source 210 may be configured to emit non-white light and the first optical receiver 212 may beconfigured to detect non-white light. The lamp 206 may be configured to emit white light using the white light source 207 to illuminate a surrounding area. The LiFi access point 208 may beconfigured to transmit data signals via the first light source 210 and to receive data signals via the first optical receiver 212. The LiFi access point 208 may also include a network interface providing communicative coupling with an internet 214.

The LiFi communication system 200 may also include a second housing 216 comprising a LiFi dongle 218 having a second light source 220 and a second optical receiver 222. The second light source 220 may be configured to emit non-white light and the second optical receiver 222 may be configured to detect non-white light. The LiFi dongle 218 may be configured to transmit data signals via the second light source 220 and to receive data signals via the second optical receiver 222. The LiFi dongle 218 may also include an interface providing communicative coupling with a computing unit 224.

The LiFi access point 208 and the LiFi dongle 218 may be photonically coupled via the first and second light sources 210, 220 and the first and second optical receivers 212, 222.

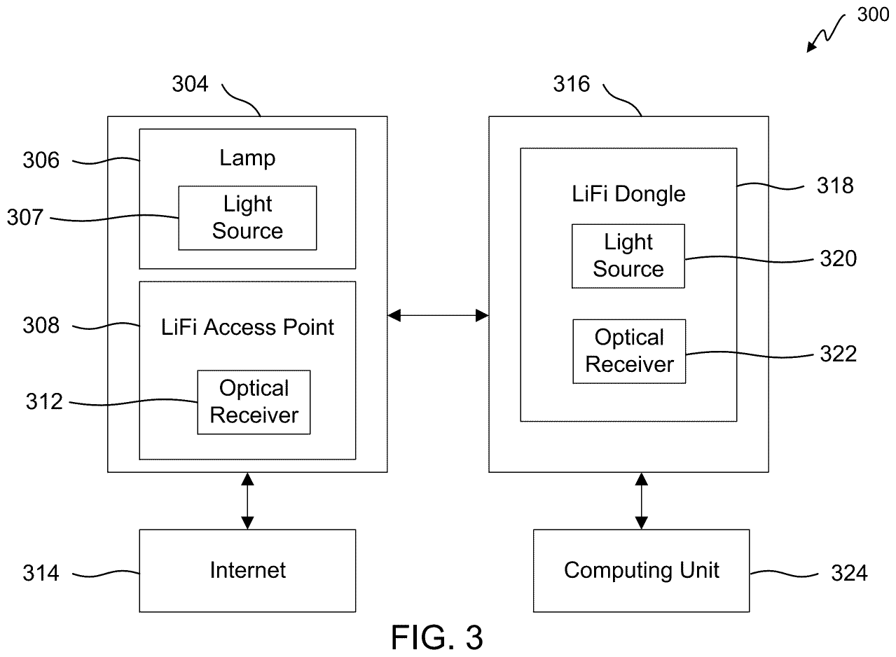

FIG. 3 is a simplified block diagram of a LiFI communication system 300 in accordance with some embodiments. This example includes a first housing 304 comprising a lamp 306 having a first light source 307 and a LiFi access point 308 having a first optical receiver 312. The lamp 306 may be configured to illuminate a surrounding area using the first light source 307, and the LiFi access point 308 may be configured to transmit data signals via the first light source 307 and to receive data signals via the first optical receiver 312. The LiFi access point 308 may also include a network interface providing communicative coupling with an internet 314.

The LiFI communication system 300 also includes a second housing 316 comprising a LiFi dongle 318 having a second light source 320 and a second optical receiver 322. The LiFi dongle 318 may be configured to transmit data signals via the second light source 320 and to receive data signals via the second optical receiver 322. The LiFi dongle 318 may also include an interface providing communicative coupling with a computing unit 324.

The LiFi access point 308 and the LiFi dongle 318 may be photonically coupled via the first and second light sources 307, 320 and the first and second optical receivers 312, 322.

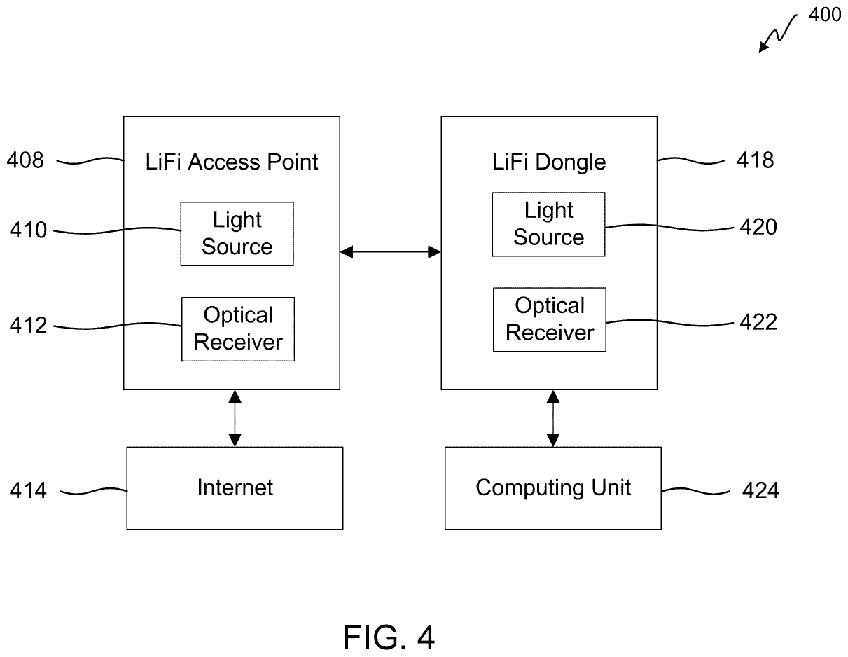

FIG. 4 is a simplified block diagram of a LiFI communication system 400 in accordance with some embodiments. This example includes a LiFi access point 408 having a first light source 410 and a first optical receiver 412. The LiFi access point 408 may be configured to transmit data signals via the first light source 410 and to receive data signals via the first optical receiver 412. The LiFi access point 408 may also include a network interface providing communicative coupling with an internet 414.

The LiFI communication system 400 also includes a LiFi dongle 418 having a second light source 420 and a second optical receiver 422. The LiFi dongle 418 may be configured to transmit data signals via the second light source 420 and to receive data signals via the second optical receiver 422. The LiFi dongle 418 may also include an interface providing communicative coupling with a computing unit 424.

The LiFi access point 408 and the LiFi dongle 418 may be photonically coupled via the first and second light sources 410, 420 and the first and second optical receivers 412, 422.

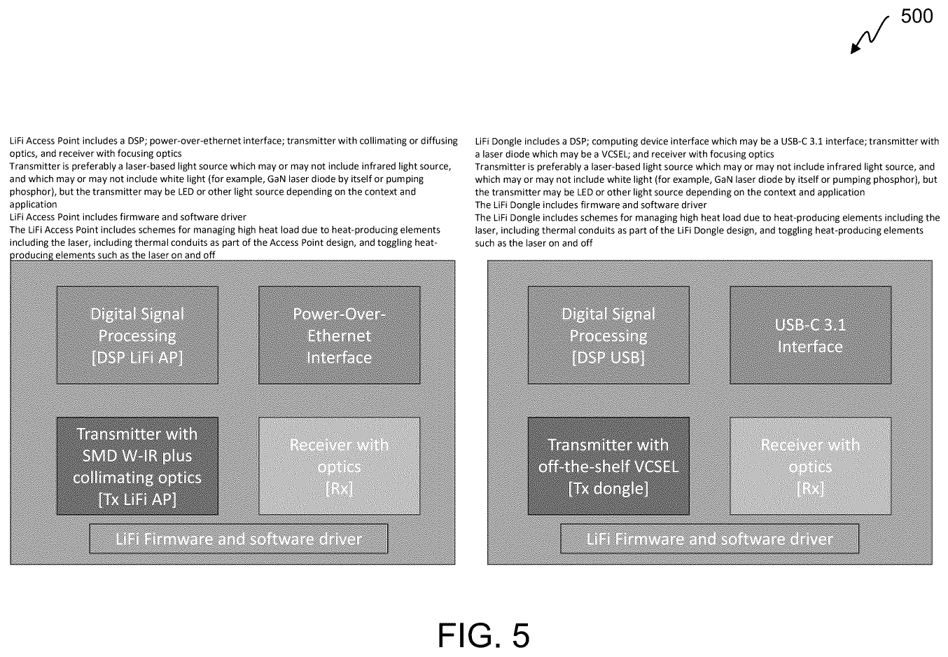

As shown in the simplified block diagrams 500 of FIG. 5, the LiFi access point may include a processor chip which may be a digital signal processor (“DSP”), a power-over-ethernet interface, as well as a transmitter with collimating or diffusing optics, as well as receiver optics that may be configured to receive light from the LiFi dongle. The LiFi access point may include firmware and a software driver to impart operating instructions between and among the access point chip devices. The LiFi access point may include schemes for managing high heat load due to the heat-producing elements including the laser or other light source. Thermal conduits and chambers may form a portion of the LiFi access point to facilitate the flow of air and conduction of heat within and out of the LiFi access point housing. Some or all of the heat-producing elements may be toggled on and off.

The LiFi dongle contains similar or the same operating elements as the LiFi access point. The LiFi dongle may include a processor chip which may be a DSP. The data interface to an attached computing device (such as a laptop computer, a desktop computer, a server computer, a mobile phone or electronic notepad, or other computing device) may be a USB-C 3.1 type of interface, PoE ethernet interface, and/or other type of interface. The LiFi dongle may include firmware and a software driver to impart operating instructions between and among the LiFi dongle chip devices. The LiFi dongle may include schemes for managing high heat load due to the heat-producing elements including the laser or other light source. Thermal conduits and chambers may form a portion of the LiFi dongle to facilitate the flow of air and conduction of heat within and out of the LiFi dongle housing. Some or all of the heat-producing elements may be toggled on and off.

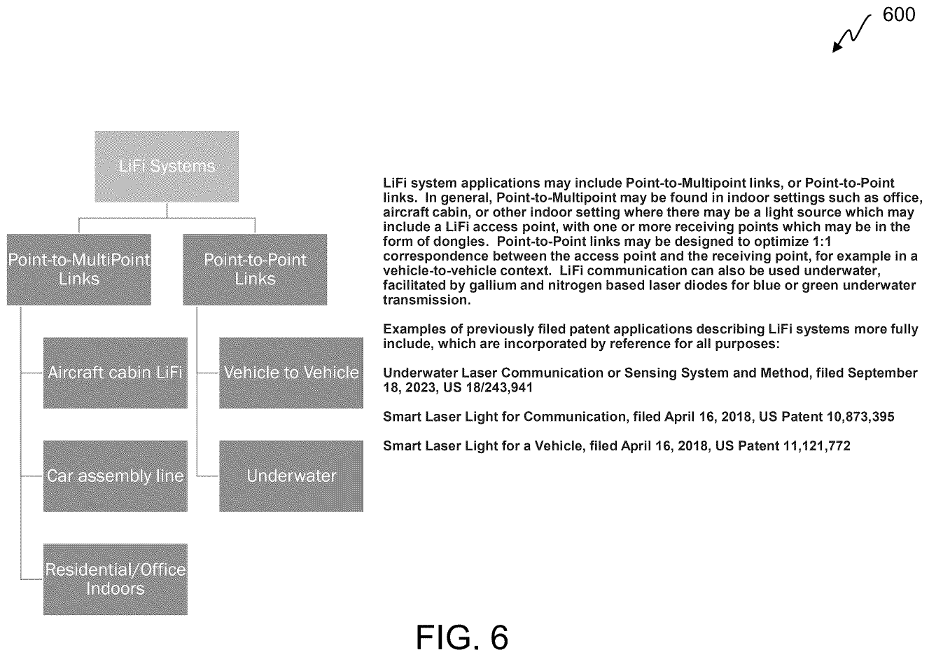

LiFi systems generally are of two types: point-to-multipoint, or point-to-point. A simplified diagram 600 of exemplary LiFi systems based on application types is shown in FIG. 6. In general, point-to-multipoint may be found in indoor settings such as an office, aircraft cabin, or other indoor setting where there may be a light source which may include a LiFi access point with one or more receiving points which may be one or more dongles. Point-to-point links may be used where 1:1 correspondence between the access point and receiving point are desired, for example in a vehicle-to-vehicle context. LiFi communication may be used in non-indoor environments as well as underwater or in space. If used underwater, the transceiver may include a GaN laser diode for blue or green light emission. If used in space, the transceiver may include a GaN laser diode for violet or ultra-violet light emission.

Examples of previously filed patent applications describing LiFi systems include, which are incorporated herein by reference for all purposes:
“Underwater Laser Communication or Sensing System and Method”, filed Sep. 8, 2023, U.S. Publication No. 2025/0085399;
“Smart Laser Light for Communication”, filed Apr. 16, 2018, U.S. Pat. No. 10,873,395; and
“Smart Laser Light for a Vehicle”, filed Apr. 16, 2018, U.S. Pat. No. 11,121,772.

Exemplary GaN laser diodes and a representative manufacturing process may be more generally described in the following patent, the contents of which are incorporated herein by reference for all purposes:
“Manufacturable Laser Diode Formed on C-Plane Gallium and Nitrogen Material”, filed Dec. 3, 2014, U.S. Pat. No. 9,368,939.

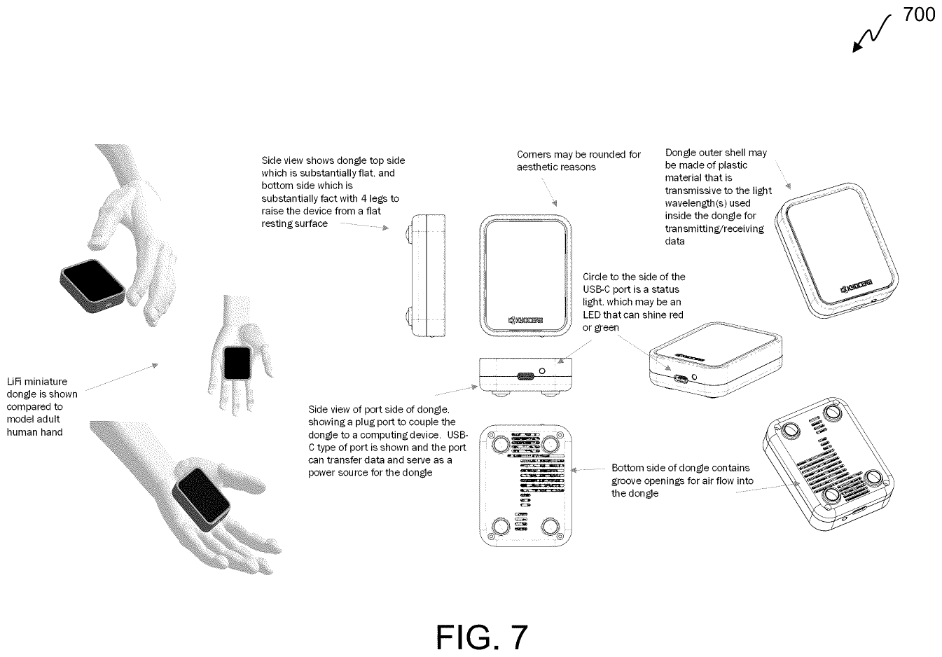

As illustrated in the examples 700 shown in FIG. 7, the LiFi dongle is preferably miniaturized so that it fits into the palm of an adult human hand. As an example, a size of the LiFi dongle may be between about 2 inches to about 5 inches in length and about 1 inch to about 3 inches in width (both +/−about 0.5 inches). Some embodiments may be shorter or longer and/or narrower or wider. The LiFi dongle may be rectangular shaped with rounded corners. The LiFi dongle may have a height to house a printed circuit board (“PCB”) with devices attached, the PCB may include holes (it may be said “vias”) which may be filled with thermally conductive material such as copper to aid heat transfer through and within the PCB. There may be a set of thermal management chambers to facilitate air flow. Groove openings on the bottom side of the LiFi dongle may allow for convection air flow into the housing. The housing may or may not include a fan to increase the convection air flow. The bottom side of the LiFi dongle may include legs to raise the housing from a flat resting surface, the legs which may be just long enough to set up a space underneath the housing through which air may flow.

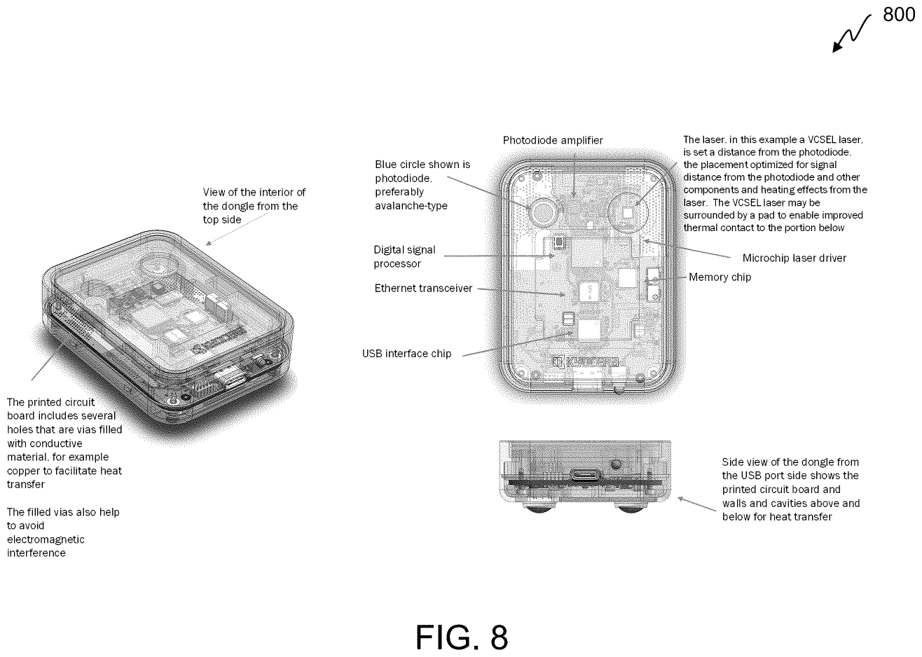

Inside the LiFi dongle housing there is a PCB as shown in the examples 800 of FIG. 8 into which several holes may be opened to allow for heat transfer. The holes may be open to allow for convection air flow, or they may be filled with a heat conducting material such as copper to provide a heat conduction path. Filled holes also can help to prevent electromagnetic interference for the dongle. The PCB may include different numbers of holes around the areas where the laser and the photodiode are located. For example, the PCB may include more holes around the area where the laser is located than the area where the photodiode is located.

The PCB may include a laser, which may be a GaN laser diode or may be a VCSEL or other type of laser. The laser is electrically coupled to a microchip laser driver. The PCB also includes a photodiode, preferably avalanche-type, with a photodiode amplifier. Data digitization may occur by way of a digital signal processor chip. The PCB may also includes an ethernet transceiver and a memory chip. An interface chip may be placed near the interface port, which may be a USB-C type of interface. A side view of the LiFi dongle on the USB port side shows an indicator light which may be green for data link, and red for no data link. Below and above the PCB there may be open space which may be part of a chamber scheme to allow for air flow.

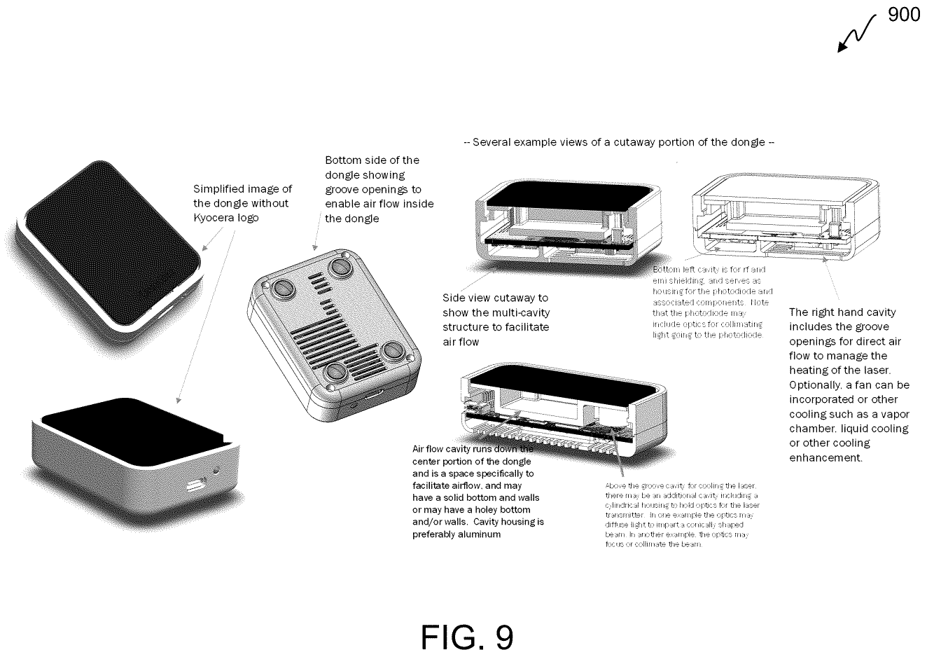

FIG. 9 includes exemplary lateral cutaway views 900 of the LiFi dongle and shows a cavity chamber sitting above the PCB which may extend through a large portion of the length of the LiFi dongle. The cavity chamber may be made of aluminum for light mass as well as good heat conduction. The cavity chamber may have a solid floor and solid walls, or may have openings in the floor or walls or both for increased airflow. Below the PCB, in some configurations, there are at least two cavities for air flow. One cavity is placed below the photodiode and may serve as electromagnetic interference and RF shielding as well as providing a housing to protect the portion of the photodiode that may stick out the bottom of the PCB. The other cavity may be below the laser, the cavity including groove openings out the bottom of the LiFi dongle to impart and direct air flow to help to keep the laser cool. Optionally, a fan or other cooling mechanism such as vapor chamber or liquid cooling or other type of cooling element may be included to bolster the cooling ability of the area around the laser.

An exemplary longitudinal cutaway view of the LiFi dongle shows a cavity section above the laser that holds a cylinder to contain optics for the laser.

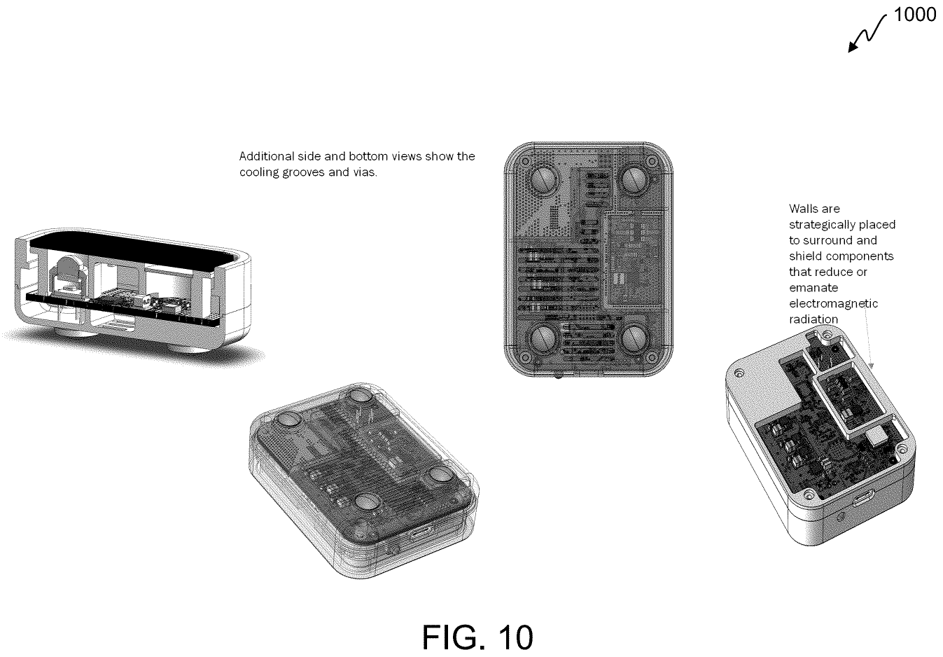

The bottom portion of the LiFi dongle housing may include grooves to open the interior of the LiFi dongle to the environment so as to impart airflow. The portion of the PCB that includes electromagnetic radiation emanating from the chip components may include walls surrounding the electromagnetic radiation emanating chips to serve as an electromagnetic shield from other portions of the LiFi dongle. Examples 1000 are provided in FIG. 10.

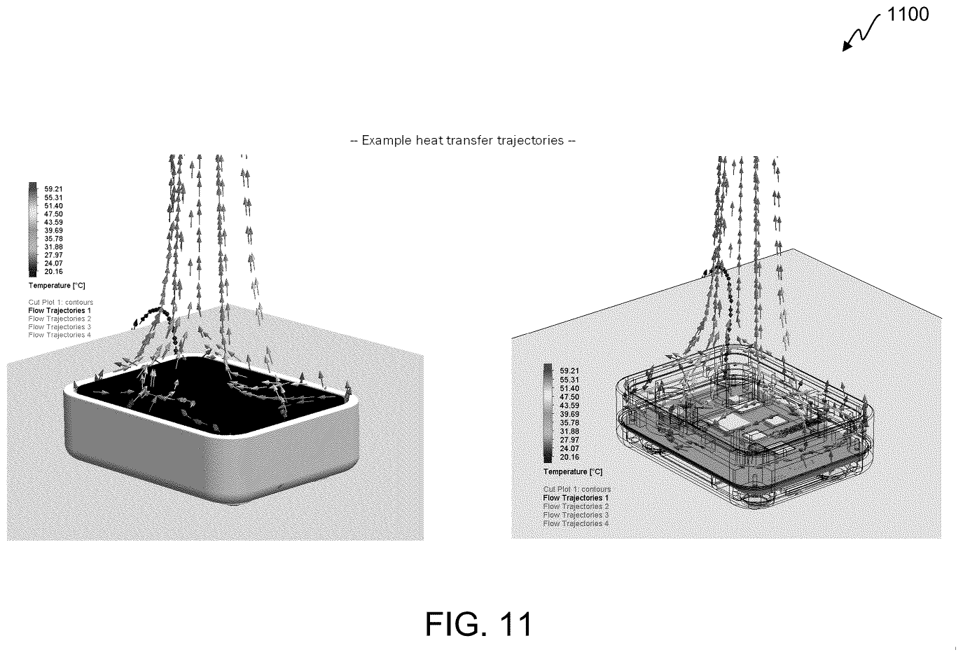

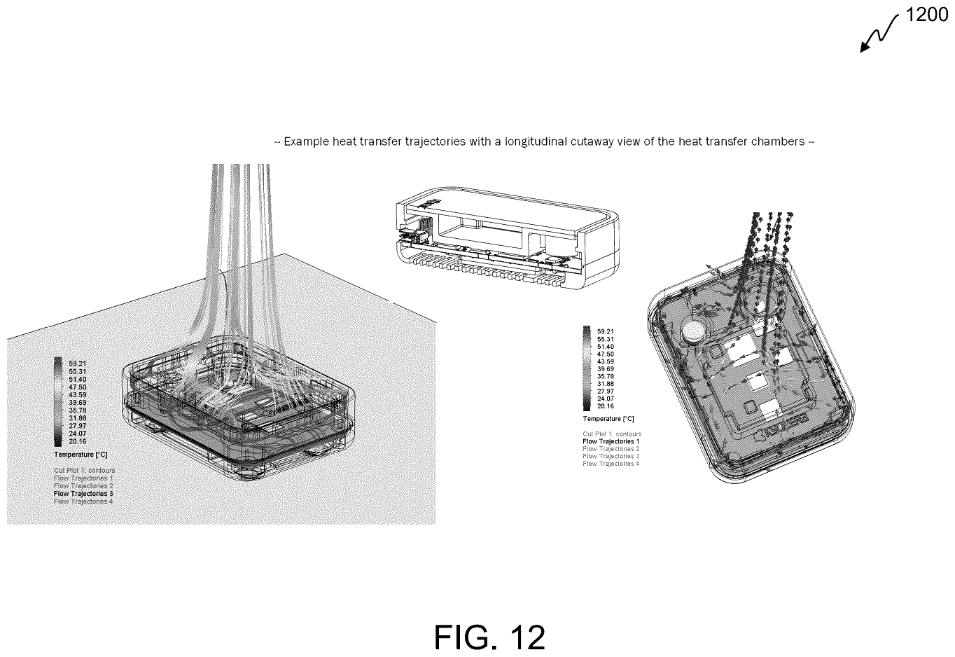

Additional exemplary views 1100, 1200 of the LiFi dongle in FIGS. 11-12 show heat transfer trajectories wherein heat flows out the top of the dongle itself as well as the perimeter space between the edge of the LiFi dongle and the dongle cover.

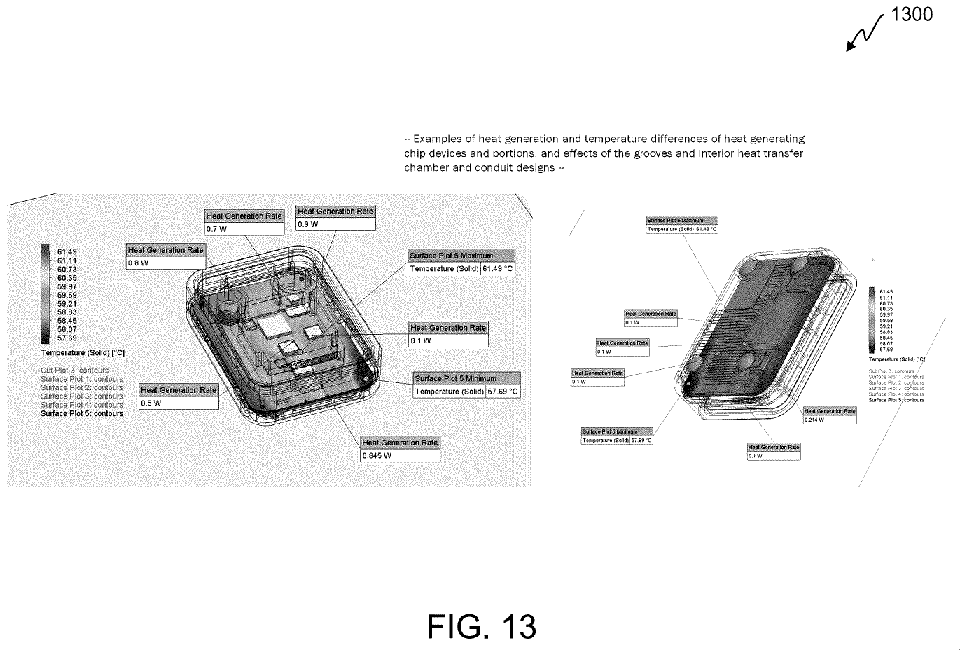

Additional exemplary views 1300 of the LiFi dongle in FIG. 13 show measured power and temperature differences in different areas of the LiFi dongle.

Other embodiments and configurations may be used by those skilled in the art.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of exemplary embodiments has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an”, or “the” is intended to mean “one or more” unless specifically indicated to the contrary.

All patents, patent applications, publications, and descriptions mentioned are incorporated herein by reference in their entirety for all purposes. None is admitted to be related art.

What is claimed is:

1. A Light Fidelity (LiFi) communication system, comprising:
a first housing comprising a lamp having a white light source and a LiFi access point having a first light source and a first optical receiver, the first light source configured to emit non-white light and the first optical receiver configured to detect non-white light, the lamp configured to emit white light using the white light source to illuminate a surrounding area, and the LiFi access point configured to transmit data signals via the first light source and to receive data signals via the first optical receiver, the LiFi access point also including a network interface providing communicative coupling with an internet; and
a second housing comprising a LiFi dongle having a second light source and a second optical receiver, the second light source configured to emit non-white light and the second optical receiver configured to detect non-white light, the LiFi dongle configured to transmit data signals via the second light source and to receive data signals via the second optical receiver, the LiFi dongle also including an interface providing communicative coupling with a computing unit;
wherein the LiFi access point and the LiFi dongle are photonically coupled via the first and second light sources and the first and second optical receivers.

2. The LiFi communication system of claim 1 wherein the first light source of the LiFi access point includes a gallium and nitrogen containing laser diode configured to emit at least one of blue, green, violet, or infrared light.

3. The LiFi communication system of claim 1 wherein the first optical receiver of the LiFi access point includes a photodiode configured to receive the data signals transmitted from the LiFi dongle.

4. The LiFi communication system of claim 1 wherein the second light source of the LiFi dongle includes a gallium and nitrogen containing laser diode.

5. The LiFi communication system of claim 1 wherein the second optical receiver of the LiFi dongle includes a photodiode configured to receive the data signals transmitted from the LiFi access point.

6. The LiFi communication system of claim 1 wherein the LiFi dongle is rectangular shaped and has a size of between about 2 inches to about 4 inches in length and about 1 inch to about 2 inches in width.

7. The LiFi communication system of claim 1 wherein the second light source and the second optical receiver of the LiFi dongle are coupled to a printed circuit board (PCB), and the PCB includes holes to aid in heat transfer through and within the PCB.

8. The LiFi communication system of claim 1 wherein the second light source and the second optical receiver of the LiFi dongle are coupled to a printed circuit board (PCB), and the second housing also includes one or more aluminum chambers arranged above and/or below the PCB.

9. A Light Fidelity (LiFi) communication system, comprising:
a first housing comprising a lamp having a first light source and a LiFi access point having a first optical receiver, the lamp configured to illuminate a surrounding area using the first light source, and the LiFi access point configured to transmit data signals via the first light source and to receive data signals via the first optical receiver, the LiFi access point also including a network interface providing communicative coupling with an internet; and
a second housing comprising a LiFi dongle having a second light source and a second optical receiver, the LiFi dongle configured to transmit data signals via the second light source and to receive data signals via the second optical receiver, the LiFi dongle also including an interface providing communicative coupling with a computing unit;
wherein the LiFi access point and the LiFi dongle are photonically coupled via the first and second light sources and the first and second optical receivers.

10. The LiFi communication system of claim 9 wherein the first light source of the lamp includes a gallium and nitrogen containing laser diode and is configured to emit white light.

11. The LiFi communication system of claim 9 wherein the first optical receiver of the LiFi access point includes a photodiode configured to receive the data signals transmitted from the LiFi dongle.

12. The LiFi communication system of claim 9 wherein the second light source of the LiFi dongle includes a gallium and nitrogen containing laser diode.

13. The LiFi communication system of claim 9 wherein the second optical receiver of the LiFi dongle includes a photodiode configured to receive the data signals transmitted from the LiFi access point.

14. The LiFi communication system of claim 9 wherein the second light source and the second optical receiver of the LiFi dongle are coupled to a printed circuit board (PCB), and the second housing also includes one or more aluminum chambers arranged above and/or below the PCB.

15. A Light Fidelity (LiFi) communication system, comprising:
a LiFi access point having a first light source and a first optical receiver, the LiFi access point configured to transmit data signals via the first light source and to receive data signals via the first optical receiver, the LiFi access point also including a network interface providing communicative coupling with an internet; and
a LiFi dongle having a second light source and a second optical receiver, the LiFi dongle configured to transmit data signals via the second light source and to receive data signals via the second optical receiver, the LiFi dongle also including an interface providing communicative coupling with a computing unit;
wherein the LiFi access point and the LiFi dongle are photonically coupled via the first and second light sources and the first and second optical receivers.

16. The LiFi communication system of claim 15 wherein the first light source of the LiFi access point includes a gallium and nitrogen containing laser diode.

17. The LiFi communication system of claim 15 wherein the first optical receiver of the LiFi access point includes a photodiode configured to receive the data signals transmitted from the LiFi dongle.

18. The LiFi communication system of claim 15 wherein the second light source of the LiFi dongle includes a gallium and nitrogen containing laser diode.

19. The LiFi communication system of claim 15 wherein the second optical receiver of the LiFi dongle includes a photodiode configured to receive the data signals transmitted from the LiFi access point.

20. The LiFi communication system of claim 15 wherein the second light source and the second optical receiver of the LiFi dongle are coupled to a printed circuit board (PCB), and the second housing also includes one or more aluminum chambers arranged above and/or below the PCB.
